(19) United States
(12) Patent Application Publication
(10) Pub. No.: US 2008/0090721 A1
(43) Pub. Date: Apr. 17, 2008

(54) Catalyst including noble metal particles supported on carbon substrate and method of producing the same

(75) Inventor: Mutsuko Komoda, Tenri-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 11/907,029

(22) Filed: Oct. 9, 2007

(30) Foreign Application Priority Data
Oct. 12, 2006 (JP) 2006-278459 (P)
Aug. 3, 2007 (JP) 2007-202799 (P)

(51) Int. Cl. B01J 23/38

(52) U.S. Cl. 502/184; 502/185

(57) ABSTRACT

A catalyst includes a noble metal particles supported on a carbon substrate. The average size of the noble metal particles is 3 nm or less, and in the elements present in the surface of the carbon substrate, the number ratio of nitrogen atoms to oxygen atoms is 10% or less and the number ratio of silicon atoms to oxygen atoms is 40% or less.

This nonprovisional application is based on Japanese Patent Application Nos. 2006-278459 and 2007-202799 filed with the Japan Patent Office respectively on Oct. 12, 2006 and Aug. 3, 2007, the entire contents of which are hereby incorporated by reference.

### BACKGROUND OF THE INVENTION

1. Field of the Invention

The present invention relates to a catalyst including noble metal particles supported on a carbon substrate and a method of producing the same. The catalyst can preferably be used in fuel cells, electrochemical processes, and the like.

2. Description of the Background Art

In noble-metal-based catalysts widely used in fuel cells, electrochemical processes and the like, noble metal particles as the catalytically active component are dispersedly supported on a substrate such as of carbon in order to increase the reactive surface area and thus catalytic activity per unit weight of noble metal. Regarding the catalyst including noble metal particles on a substrate, a technique for supporting noble metal particles of smaller sizes in a highly dispersed manner on a substrate has been sought in order to reduce the amount of noble metal to be used and also to further enhance the catalytic activity of the noble metal.

In addition, in a gas-diffusible electrode used in a fuel cell or the like, it is essentially needed to form three phase interfaces of catalyst, fuel and electrolyte involved in the reaction and to increase the total areas of the interfaces thereof. In particular, since improvement of the catalytic activity greatly contributes to improvement in performance of the fuel cell, there is needed production of noble metal particles having small diameters.

Conventionally, as a method of producing a carbon powder supporting noble metal particles for use in forming a gas-diffusible electrode for a fuel cell or the like, e.g. Japanese Patent Publication No. 61-001869 discloses a method of dispersing carbon powder in an aqueous solution of a platinum compound such as platinic chloride, tetraammine platinum-(II) chloride, or dinitrodiammine platinum-(II) and after stabilization, reducing platinum complex ions on the carbon powder using a reducing agent, thereby forming platinum particles sticking on the carbon powder. However, this method requires the use of a special platinum compound and a reducing agent and thus involves a problem in terms of manufacturing costs and manufacturability.

Japanese Patent Publication No. 63-046958 proposes a colloid method in which a dispersant is used so that platinum particles of a minute size can be supported on carbon powder. However, this method uses protective colloid and thus involves a problem in that the protective colloid easily remains on the catalyst surface and the platinum particles hardly exhibit good catalytic activity.

Japanese Patent No. 2879649 discloses a method in which a functional group is formed on a surface of carbon powder by oxidation and then an ion present in the functional group is subjected to ion-exchange with a platinum complex cation, thereby forming platinum particles supported on carbon powder. However, this method involves a problem in that it is difficult to adjust the condition of surface treatment of the carbon powder.

As described above, with the conventional techniques as disclosed in Japanese Patent Publication No. 61-001869, Japanese Patent Publication No. 63-046958 and Japanese Patent No. 2879649, it is difficult to readily and surely obtain at low costs a carbon powder supporting noble metal particles having excellent catalytic activity.

### SUMMARY OF THE INVENTION

In view of the situations of the conventional techniques as described above, an object of the present invention is to provide a catalyst including noble metal particles excellent in catalytic activity on a carbon substrate, in which minute noble metal particles are uniformly supported with good dispersiveness on the carbon substrate.

A catalyst according to the present invention includes noble metal particles supported on a carbon substrate. The average size of the noble metal particles is 3 nm or less. In elements present in a surface of the carbon substrate, a number ratio of nitrogen atoms to oxygen atoms is 10% or less and a number ratio of silicon atoms to oxygen atoms is 40% or less.

A method of producing the catalyst preferably includes the steps of preparing a carbon powder dispersion liquid by dispersing carbon powder for the carbon substrate into a solvent; and adding a noble metal solution to the carbon powder dispersion liquid to form the noble metal particles supported on the carbon substrate.

In this case, it is,preferable that at least one of the carbon powder dispersion liquid and the noble metal solution further includes a polymer pigment dispersant. The polymer pigment dispersant is preferably an amphipathic polymer. The amphipathic polymer preferably includes a compound having an amino group and an ether group. The polymer pigment dispersant is preferably removed after the noble metal particles are supported on the carbon substrate.

The carbon powder dispersion liquid is preferably subjected to a crushing process. It is preferable that the solvent having the carbon powder dispersed therein is alcohol, and the absolute value of zeta potential of the carbon powder dispersion liquid is 30 mV or higher. The carbon powder dispersion liquid preferably has pH higher than 7.

It is preferable to heat a mixture liquid prepared by adding the noble metal solution to the carbon powder dispersion liquid. After the heating, the mixture liquid is preferably cooled at a higher rate as compared with natural cooling in an ambient air.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a graph showing relation between current density, voltage and output power density for MEAs of Example 1 and Comparative Example 1.

FIG. 2 is a graph showing time-dependent variations of voltage under a constant current load for MEAs of Example 1 and Comparative Example 1.

FIG. 3 is a graph showing relation between current density, voltage and output density for MEAs of Example 1 and Comparative Example 2.

FIG. 4 is a graph showing time-dependent variations of voltage under a constant current load for MEAs of Example 1 and Comparative Example 2.

FIG. 5 is a graph showing relation between current density, voltage and output density for MEAs of Example 1 and Comparative Example 3.

FIG. 6 is a graph showing time-dependent variations of voltage under a constant current load for MEAs of Example 1 and Comparative Example 3.

FIG. 7 is a graph showing relation between current density, voltage and output density for MEAs of Example 1 and Comparative Example 4.

FIG. 8 is a graph showing time-dependent variations of voltage under a constant current load for MEAs of Example 1 and Comparative Example 4.

FIG. 9 is a graph showing relation between current density, voltage and output. density for MEAs of Example 1, Example 2 and Example 3.

FIG. 10 is a graph showing time-dependent variations of voltage under a constant current load for MEAs of Example 1, Example 2 and Example 3.

### DESCRIPTION OF THE PREFERRED EMBODIMENTS

The present invention relates to a catalyst including noble metal particles supported on a carbon substrate. In the present invention, the noble metal means platinum group elements, gold (Au) or silver (Ag). It is noted that platinum group elements include ruthenium (Ru), rhodium (Rh), palladium (Pd), osmium (Os), iridium (Ir), and platinum (Pt). The noble metal particles may be formed of only one kind of these noble metals or may be formed of a mixture or an alloy of two or more kinds.

In the present invention, the noble metal particles supported on the carbon substrate may most typically be formed of platinum or an alloy containing platinum. The catalyst including noble metal particles on a carbon substrate according to the present invention can be used, e.g., as a catalyst for a positive or negative electrode of a fuel cell. An example of the typical catalyst for the positive electrode may be a catalyst including platinum particles on a substrate, and an example of the typical catalyst for the negative electrode may be a catalyst including platinum-ruthenium alloy particles on a substrate.

In the catalyst including noble metal particles on a carbon substrate according to the present invention, the average size of the noble metal particles is 3 nm or less. The reason is that in the case of the average particle size exceeding 3 nm, the specific surface of the noble metal particles is too small to sufficiently exhibit catalytic performance. On the other hand, the average particle size is preferably 1 nm or more in view of manufacturability.

Here, the average size of the noble metal particles can be determined by a measurement result of a diffraction peak using an X-ray diffractometer and the Scherrer equation.

In the elements present in the surface of the carbon substrate supporting noble metal particles included in the catalyst according to the present invention, the number ratio of nitrogen atoms to oxygen atoms is 10% or less, and the number ratio of silicon atoms to oxygen atoms is 40% or less. If a large amount of elements other than carbon (C) up to the third column of the periodic table is included in the surface of the carbon substrate, catalytic reaction and electric conduction are restricted, and thus the amount of elements other than carbon up to the third column of the periodic table is preferably as small as possible. If the number ratio of nitrogen atoms to oxygen atoms in the surface of the carbon substrate exceeds 10%, catalytic reaction and electric conduction are restricted and it is difficult to obtain sufficient catalytic activity. On the other hand, if the number ratio of silicon atoms to oxygen atoms in the surface of the carbon substrate exceeds 40%, catalytic activity and electric conduction are also restricted and it is difficult to obtain sufficient catalytic activity.

It is noted that the number ratio of nitrogen atoms to oxygen atoms and the number ratio of silicon atoms to oxygen atoms in the surface of the carbon substrate can be evaluated by element analysis, e.g., using a wave dispersive X-ray analyzer.

Examples of the carbon substrate for use in the catalyst according to the present invention may be Ketjenblack (manufactured by Ketjenblack International Corporation), Vulcan XC72 and Vulcan XC72R (both manufactured by Cabot Corporation), and the like. Ketjenblack can preferably be used because it has a large specific surface, excellent ability to carry noble metal particles and good electrochemical characteristics.

In the catalyst according to the present invention, the noble metal particles supported on the carbon substrate may be in a range of 30-50 wt. %, for example. In the case of the proportion of noble metal particles being 30 wt. % or more, good catalytic activity can be obtained, and in the case of 50 wt. % or less, aggregation of the noble metal particles can be prevented and excessive increase in manufacturing cost may also be prevented.

(Method of Producing Catalyst Including Noble Metal Particles on Carbon Substrate)

Accordance to the present invention, a method of producing a catalyst includes the steps of preparing a carbon powder dispersion liquid by dispersing carbon powder for a carbon substrate in a solvent, and adding a noble metal solution to the carbon powder dispersion liquid to form noble metal particles supported on the carbon substrate, wherein the average particle size of noble metal particles on the carbon substrate is 3 nm or less, and the number ratio of nitrogen atoms to oxygen atoms is 10% or less and the number ratio of silicon atoms to oxygen atoms is 40% or less in elements present at the surface of the carbon substrate.

(Preparation of Carbon Powder Dispersion Liquid)

A carbon powder dispersion liquid is first prepared by dispersing carbon powder in a solvent. Examples of the solvent for dispersion may be alcohols, glycols, and the like. Alcohols are preferable in that they can also be used as a solvent for noble metal solution, in that they have good ability to disperse carbon powder, and in that removal thereof is easy.

In the present invention, at least one of the carbon powder dispersion liquid and the noble metal solution preferably includes a polymer pigment dispersant. In this case, aggregation of noble metal particles can be prevented, and they can uniformly be supported with good dispersiveness on the carbon substrate. In particular, inclusion of the polymer pigment dispersant in the carbon powder dispersion liquid is preferable in that the dispersiveness of carbon powder in the solvent is improved. Here, in the case that at least one of the carbon powder dispersion liquid and the noble metal solution includes the polymer pigment dispersant, it is preferable to conduct a treatment for removing the polymer pigment dispersant to prevent residues thereof, after noble metal particles are supported on the carbon substrate.

As a polymer pigment dispersant, it is possible to use, e.g. a dispersant including polypropylene oxide as a base resin.

Furthermore, it is preferable to use amphipathic polymer as a polymer pigment dispersant. As described earlier, if a large amount of elements other than carbon (C) up to the third column of the periodic table is included in the surface of the carbon substrate, catalytic reaction and electric conduction are restricted, and thus it is preferable that the amount of elements other than carbon up to the third column of the periodic table is as small as possible. In particular, an element such as sulfur (S) or silicon (Si) is liable to remain as a component derived from the starting material or the dispersant and needs to be removed by complicated means such as acid treatment or heat treatment. The amphipathic polymer has a surface activation effect irrespective of its ion species and is soluble in alcohol and water. In the case of using amphipathic polymer as the polymer pigment dispersant, therefore, it is easy to remove the dispersant, it is possible to sufficiently prevent residues of elements restricting catalytic reaction or electric conduction, and particularly it is possible to sufficiently reduce the number ratio of nitrogen and silicon atoms to oxygen atoms in the carbon substrate surface.

The amphipathic polymer used in the present invention preferably includes a compound having an amino group and an ether group. An amino group is easily absorbed on the carbon surface and easily coordinates with a colloidal particle formed by noble metal in the noble metal solution. Therefore, a compound having an amino group can promote dispersion of carbon powder in alcohol and also prevent aggregation of colloidal particles of the noble metal. Furthermore, a compound having an ether group has an amphipathic property and tends to easily dissolve in alcohol and water. Therefore, with use of a compound having an amino group and an ether group, it is possible to more uniformly disperse noble metal particles, and it is also possible to easily remove the polymer pigment dispersant thereby preventing residues thereof.

Examples of the compound having an amino group and an ether group may be a compound including polypropylene oxide as a base resin and monodiethylaminoalkylether as a protecting group, and the like. Specific examples of the commercially available product may be “Solsperse 20000” manufactured by Avecia, “Ajisper PN411” manufactured by Ajinomoto Co., Inc, and the like.

In preparation of the carbon powder dispersion liquid, the carbon powder is preferably subjected to a crushing process. With use of the crushing process, it becomes possible to improve stability and uniformity of carbon powder dispersion in a solvent, and then it becomes possible to more uniformly disperse nucleation sites in reduction precipitation of noble metal particles as described later. The crushing process may be performed using a crusher, a paint conditioner, an attritor, a bead mill, or the like.

The carbon powder dispersion liquid is preferably prepared such that it has an absolute value of zeta potential of 30 mV or higher. In the case of such a zeta potential, the dispersiveness of carbon powder in the solvent is good and it is possible to more uniformly disperse nucleation sites in reduction precipitation of noble metal particles. As a result, colloidal particles of the noble metal can more uniformly be dispersed on the surface of the carbon substrate, and then noble metal particles having smaller sizes can more uniformly be supported with good dispersiveness on the carbon substrate. This advantage can more effectively be obtained particularly in the case of using a carbon powder dispersion liquid that includes alcohol as a solvent for dispersion and has an absolute value of zeta potential of 30 mV or higher.

While a higher absolute value of zeta potential of the carbon powder dispersion liquid is preferable in terms of the dispersiveness of carbon powder, the absolute value of about 70 mV, for example, can achieve the aforementioned advantage well enough. In the present invention, the absolute value of zeta potential of the carbon powder dispersion liquid can be 80 mV or lower, for example.

Most typically, the carbon powder dispersion liquid is preferably prepared such that alcohol is used as the solvent for dispersion, the carbon powder content is about 0.5 g in 100 mL solvent, and the absolute value of zeta potential is 30 mV or higher.

Here, the zeta potential can be evaluated by electrophoresis, e.g., using a zeta potential analyzer.

(Supporting Noble Metal Particles on Carbon Substrate)

Noble metal particles are supported on a carbon substrate by adding a noble metal solution to the carbon powder dispersion liquid prepared as described above. In the present invention, the noble metal solution means a solution or a colloidal solution including a noble metal element and typically means a solution or a colloidal solution including a cation, in particular, a complex ion of a noble metal element. As such a noble metal solution, it is possible to use, e.g. a solution or a colloidal solution of salt or complex salt of the noble metal. Examples of the salt of noble metal may be ruthenium chloride, ruthenium nitrosyl complex, ruthenium ammine complex, ruthenium carbonyl complex, and the like. Examples of the complex salt of noble metal may be platinic chloride, platinum ammine complex, platinum carbonyl complex, and the like.

In the present invention, the noble metal solution preferably includes a polymer pigment dispersant. In this case, it is possible to prevent aggregation of noble metal particles, and thus it is possible to more finely and-uniformly carry noble metal particles on a carbon substrate. Preferable examples of the polymer pigment dispersant may be similar ones as mentioned regarding the preparation of the carbon powder dispersion liquid. The amphipathic polymer as described above is more preferable, and the amphipathic polymer including a compound having an amino group and an ether group as described above is especially preferable.

The carbon powder dispersion liquid with addition of the noble metal solution is boiled for about one hour and thereafter cooled to a room temperature, and then suction filtration, drying and the like are carried out as appropriate, whereby the noble metal particles reduced and precipitated from the noble metal solution can be supported on the carbon substrate. With the method in this manner according to the present invention, it is possible to obtain a catalyst including noble metal particles on a carbon substrate.

More specifically, in the case that a solution prepared by dissolving platinic chloride in alcohol such as propanol is used as the noble metal solution, it is possible to obtain a catalyst including platinum particles on a carbon substrate. This catalyst including platinum particles is useful, e.g., as a catalyst for a positive electrode of a fuel cell.

Furthermore, a dispersion solution can be prepared by dispersing such carbon powder supporting platinum particles as obtained above in alcohol such as propanol, which is then boiled for about two hours with addition of an alcohol solution of ruthenium chloride and cooled to a room temperature. The cooled dispersion solution is then subjected to suction filtration, drying and the like, and further subjected to burning in a reducing atmosphere of a gas mixture containing 10% hydrogen and the balance of nitrogen, resulting in a catalyst including platinum-ruthenium alloy particles on a carbon substrate. This catalyst including platinum-ruthenium alloy particles is useful, e.g., as a catalyst for a negative electrode of a fuel cell.

In the following, Examples of the present invention will be described more specifically.

(Evaluation Method)

(Zeta Potential)

The zeta potential of the carbon powder dispersion liquid was measured by electrophoresis using a zeta potential analyzer (manufactured by Otsuka Electronics Co., Ltd.) under the condition that the solvent is n-propanol and the concentration of the dispersion solution is 0.5 wt. % (carbon equivalent weight).

(Average Size of Noble Metal Particles Supported on Carbon Substrate)

The diffraction peak was measured by an X-ray diffractometer (manufactured by Rigaku Corporation) and the average particle size was calculated by the Scherrer equation. The maximum particle size was determined by extracting 200 noble metal particulates using a transmission electron microscope (manufactured by Hitachi High-Technologies Corporation) and measuring the maximum size in these noble metal particulates.

(Number Ratio of Atoms in Elements Present in Surface of Carbon Substrate)

Element analysis on the carbon substrate surface was carried out using a wave dispersive X-ray analyzer (manufactured by Shimadzu Corporation) to evaluate the number ratio of atoms in various elements present in the surface.

(Power Generation Characteristic)

Each of MEAs (Membrane Electrode Assemblies) prepared in Examples 1-3 and Comparative Examples 1-4 as described later was set in a commercially available standard cell (manufactured by Electrochem Inc.). The cell was then measured to determine its current-voltage curve and its time-dependent voltage variations under 0.1 A/cm² constant current load for five hours with an electronic load device, under the condition that 3 mol/L methanol aqueous solution was supplied at 300 μL/min to the negative electrode, air was supplied at 500 mL/min to the positive electrode, and temperature of the cell was 40° C.

### EXAMPLE 1

A carbon powder dispersion liquid was prepared by dispersing 0.22 g of Ketjenblack (manufactured by Ketjenblack International Corporation) having a primary particle size of 30-40 nm in 50 mL of 1-propylalcohol as a solvent for dispersion, and adding 7 mL of Solsperse 20000 (manufactured by Avecia) as a polymer pigment dispersant. This carbon powder dispersion liquid was stirred for 10 minutes using a crusher at 24,000 revolutions/min. The zeta potential of the carbon powder dispersion liquid was +65 mV after the stirring.

Thereafter, the carbon powder dispersion liquid was boiled for one hour with addition of 25 mL 1-propanol solution including 0.38 wt. % platinic chloride. After cooling to a room temperature, suction filtration and drying at 60° C. were performed to prepare a catalyst having about 24 wt. % of platinum particles supported on the carbon powder as a carbon substrate. This catalyst was used as a catalyst for a positive electrode of a fuel cell.

Here, in this Example 1, the average size of the platinum particles supported on the carbon powder was 2 nm according to the result of X-ray diffraction measurement.

On the other hand, a propanol dispersion solution including 40 wt. % of the carbon powder supporting platinum particles prepared by the method as described above was boiled for two hours with addition of 10.0 mL propanol solution including 0.34 wt. % ruthenium chloride. After cooling to a room temperature, suction filtration and drying at 60° C. were performed, and then burning was performed for one hour at 200° C. in a gas mixture containing 10% hydrogen and the balance of nitrogen. Thus, there was obtained a catalyst including platinum-ruthenium alloy particles supported on the carbon powder as a carbon substrate, in which the amount of platinum was 21 wt. % and the amount of ruthenium was about 11 wt. % with respect to the total weight. This catalyst was used as a catalyst for a negative electrode of the fuel cell.

Here, in this Example 1, the average size of the platinum ruthenium alloy particles supported on the carbon powder was 2.5 nm according to the result of X-ray diffraction measurement.

In the present Example 1, elements present in the carbon surface of the catalyst for the positive electrode were 97.0% C, 2.4% Pt, 0.05% N, and 0.55% O by the number ratio of atoms, while elements present in the carbon surface of the catalyst for the negative electrode were 91.56% C, 3.9% Pt, 3.8% Ru, 0.06% N, and 0.68% O by the number ratio of atoms. Then, no element other than these was detected in the carbon surface.

In the present Example 1, therefore, the number ratio of nitrogen atoms to oxygen atoms was 0.05/0.55×100=about 9.1% and the number ratio of silicon atoms to oxygen atoms was 0% in the carbon surface of the catalyst for the positive electrode. On the other hand, the number ratio of nitrogen atoms to oxygen atoms was 0.06/0.68×100=about 8.8% and the number ratio of silicon atoms to oxygen atoms was 0% in the carbon surface of the catalyst for the negative electrode.

Each of the catalyst including platinum particles for the positive electrode and the catalyst including platinum-ruthenium alloy particles for the negative electrode was immersed in a dispersion liquid (Nafion solution manufactured by Aldrich Corp.) including 20% of solid polymer electrolyte to form a suspension with addition of 2-propanol. The suspension was then stirred for about 30 minutes with a planetary ball mill made of zirconia. In this way, a positive electrode catalyst paste was obtained from the catalyst for the positive electrode and a negative electrode catalyst paste was obtained from the catalyst for the negative electrode.

These positive electrode catalyst paste and negative electrode catalyst paste were respectively applied to carbon paper (manufactured by Toray Industries Inc.) using a bar coater to form a positive electrode catalyst layer and a negative electrode catalyst layer.

An electrolytic solid polymer film (Nafion manufactured by DuPont Corp.) was sandwiched between the positive electrode catalyst layer and the negative electrode catalyst layer and joined to them by hot press to form an MEA of this Example 1.

### EXAMPLE 2

A carbon powder dispersion liquid similar to that of Example 1 was boiled for one hour with addition of 25 mL 1-propanol solution including 0.38 wt. % platinic chloride. After it was immersed in ice water for 30 minutes, suction filtration and drying at 60° C. were performed to prepare a catalyst having about 30 wt. % platinum particles supported on the carbon powder. This catalyst including platinum particles was used as a catalyst for a positive electrode of a fuel cell.

Here, in this Example 2, the average size of the platinum particles supported on the carbon powder was 2.2 nm according to the result of X-ray diffraction measurement.

On the other hand, a catalyst used for a negative electrode of the fuel cell in this Example 2 was one similar to that of Example 1.

In this Example 2, elements present in the carbon surface of the catalyst for the positive electrode were 96.47% C, 2.8% Pt, 0.03% N, and 0.7% O by the number ratio of atoms. Then, no element other than these was detected in the carbon surface. In the carbon surface of the catalyst for the positive electrode, therefore, the number ratio of nitrogen atoms to oxygen atoms was 0.03/0.70×100=about 4.3% and the number ratio of silicon atoms to oxygen atoms was 0%.

An MEA was prepared by a similar process as in Example 1, using the catalyst for the positive electrode and the catalyst for the negative electrode according to this Example 2.

### EXAMPLE 3

25 mL 1-propanol solution including 0.38 wt. % platinic chloride was added to a carbon powder dispersion liquid similar to that of Example 1, and then stirred over day and night with pH adjusted to 11 using n-propanol solution including NaOH at a concentration in a range of 0.1-1 N. Here, it is preferable that the pH is higher than 7. The resultant liquid was boiled for one hour and cooled to a room temperature, and then subjected to suction filtration and drying at 60° C. to prepare a catalyst having about 27 wt. % platinum particles. This catalyst including platinum particles was used as a catalyst for a positive electrode of a fuel cell.

Here, in this Example 3, the average size of the platinum particles supported on the carbon powder was 2 nm according to the result of X-ray diffraction measurement.

In this Example 3, elements present in the carbon surface of the catalyst for the positive electrode were 95.8% C, 2.7% Pt, 0.03% N, 1.05% O, and 0.38% Si by the number ratio of atoms. Then, no element other than these was detected in the carbon surface. In the carbon surface of the catalyst for the positive electrode, therefore, the number ratio of nitrogen atoms to oxygen atoms was 0.03/1.05×100=about 2.9%, and the number ratio of silicon atoms to oxygen atoms was 0.38/1.05×100=36%.

On the other hand, a catalyst used for a negative electrode of the fuel cell in this Example 3 was one similar to that of Example 1.

An MEA was prepared by a similar process as in Example 1, using the catalyst for the positive electrode and the catalyst for negative electrode according to this Example 3.

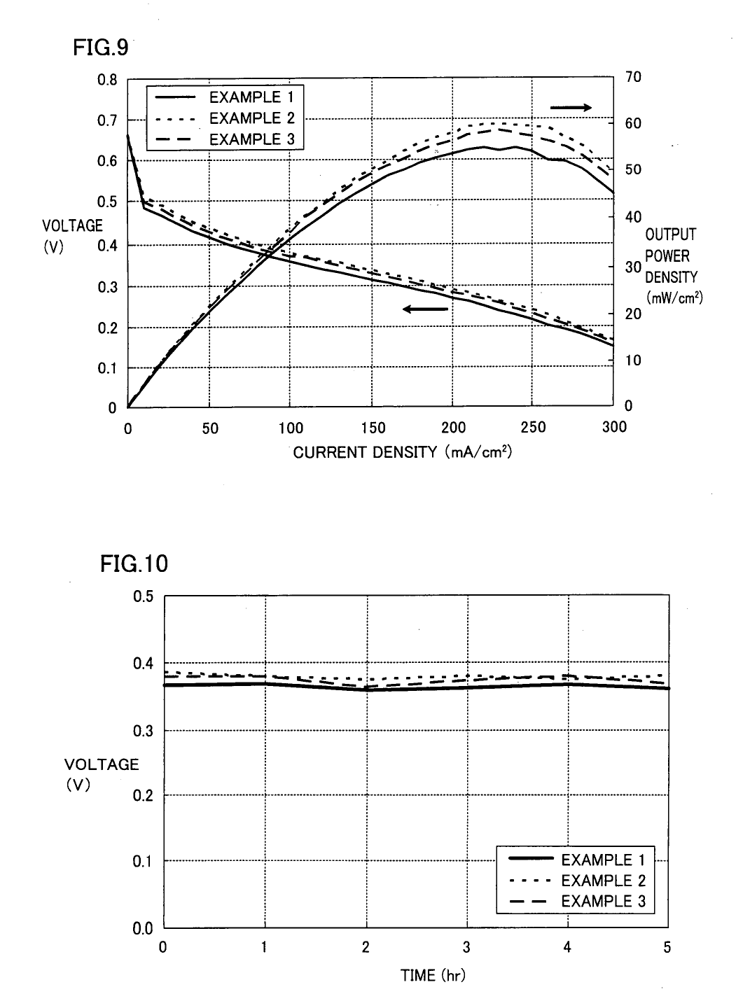

The graph in FIG. 9 shows relation between current density (mA), voltage (V) and output density (mW/cm²) for MEAs according to Example 1, Example 2, and Example 3 as described above. The graph in FIG. 10 shows time-dependent voltage variations under the constant current load for MEAs according to Example 1, Example 2, and Example 3. It can be understood from FIG. 9 and FIG. 10 that MEAs according to Example 1, Example 2, and Example 3 have their approximately equivalent excellent output characteristics.

### COMPARATIVE EXAMPLE 1

In Comparative Example 1, a catalyst for a positive electrode and a catalyst for a negative electrode were prepared by a process similar to that of Example 1, except that Solsperse 20000 as a polymer pigment dispersant was not used.

In the carbon powder dispersion liquid prepared in this Comparative Example 1, the zeta potential was −24 mV. Then, in the catalyst for the positive electrode in this Comparative Example 1, the average size of the platinum particles was 4 nm with the maximum size of 7 nm, and the amount of platinum particles was 30 wt. %.

In this Comparative Example 1, elements present in the carbon surface of the catalyst for the positive electrode were 95.0% C, 3.9% Pt, 0.08% N, and 1.0% O by the number ratio of atoms, and no element other than these was detected. In the carbon surface of the catalyst for positive electrode, therefore, the number ratio of nitrogen atoms to oxygen atoms was 8.0% and the number ratio of silicon atoms to oxygen atoms was 0%.

In the catalyst for the negative electrode in this Comparative Example 1, the average size of the platinum-ruthenium alloy particles was 5.5 nm with the maximum size of 8 nm, and the amount of platinum was 26 wt. % and the amount of ruthenium was 13 wt. %.

In this Comparative Example 1, elements present in the carbon surface of the catalyst for the negative electrode were 92.2% C, 3.3% Pt, 3.5% Ru, 0.05% N, and 0.95% O by the number ratio of atoms, and no element other than these was detected. In the carbon surface of the catalyst for the negative electrode, therefore, the number ratio of nitrogen atoms to oxygen atoms was 5.3% and the number ratio of silicon atoms to oxygen atoms was 0%.

An MEA was prepared by a similar process as in Example 1, using the catalyst for the positive electrode and the catalyst for the negative electrode according to this Comparative Example 1.

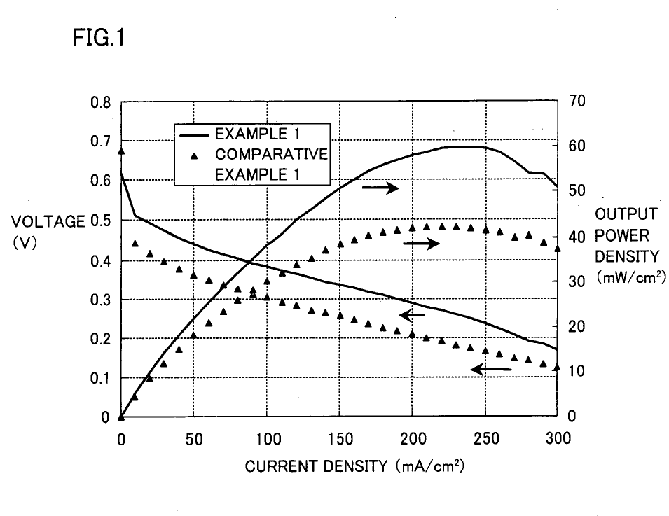

FIG. 1 is a graph showing relation between current density (mA), voltage (V) and output density (mW/cm²) for MEAs according to Example 1 and Comparative Example 1. FIG. 2 is a graph showing time-dependent voltage variations under the constant current load for MEAs according to Example 1 and Comparative Example 1.

It can be understood from FIG. 1 that the power generation efficiency is higher and thus the catalytic reaction resistance is reduced in Example 1 as compared with Comparative Example 1. In FIG. 2, the higher voltage can also be obtained under the constant current load in Example 1 as compared with Comparative Example 1.

### COMPARATIVE EXAMPLE 2

In Comparative Example 2, a catalyst for a positive electrode and a catalyst for a negative electrode were also prepared by a process similar to that of Example 1, except that the stirring using the crusher was not performed.

In a carbon powder dispersion liquid prepared in this Comparative Example 2, the zeta potential was −8 mV. Then, in the catalyst for positive electrode according to Comparative Example 2, the average size of the platinum particles was 3.5 nm with the maximum size of 5 nm, and the amount of platinum particles was 30 wt. %.

In this Comparative Example 2, elements present in the carbon surface of the catalyst for the positive electrode were 96.0% C, 3.1% Pt, 0.07% N, and 0.83% O by the number ratio of atoms, and no element other than these was detected. In the carbon surface of the catalyst for the positive electrode, therefore, the number ratio of nitrogen atoms to oxygen atoms was 8.4% and the number ratio of silicon atoms to oxygen atoms was 0%.

In the catalyst for the negative electrode in this Comparative Example 2, the average size of the platinum-ruthenium alloy particles was 3.1 nm with the maximum size of 5.0 nm, and the amount of platinum was 26 wt. % and the amount of ruthenium was 13 wt. %.

In this Comparative Example 2, elements present in the carbon surface of the catalyst for the negative electrode were 91.5% C, 3.9% Pt, 3.8% Ru, 0.06% N, and 0.7% O by the number ratio of atoms, and no element other than these was detected. In the carbon surface of the catalyst for the negative electrode, therefore, the number ratio of nitrogen atoms to oxygen atoms was 8.6% and the number ratio of silicon atoms to oxygen atoms was 0%.

An MEA was prepared by a similar process as in Example 1, using the catalyst for the positive electrode and the catalyst for the negative electrode according to this Comparative Example 2.

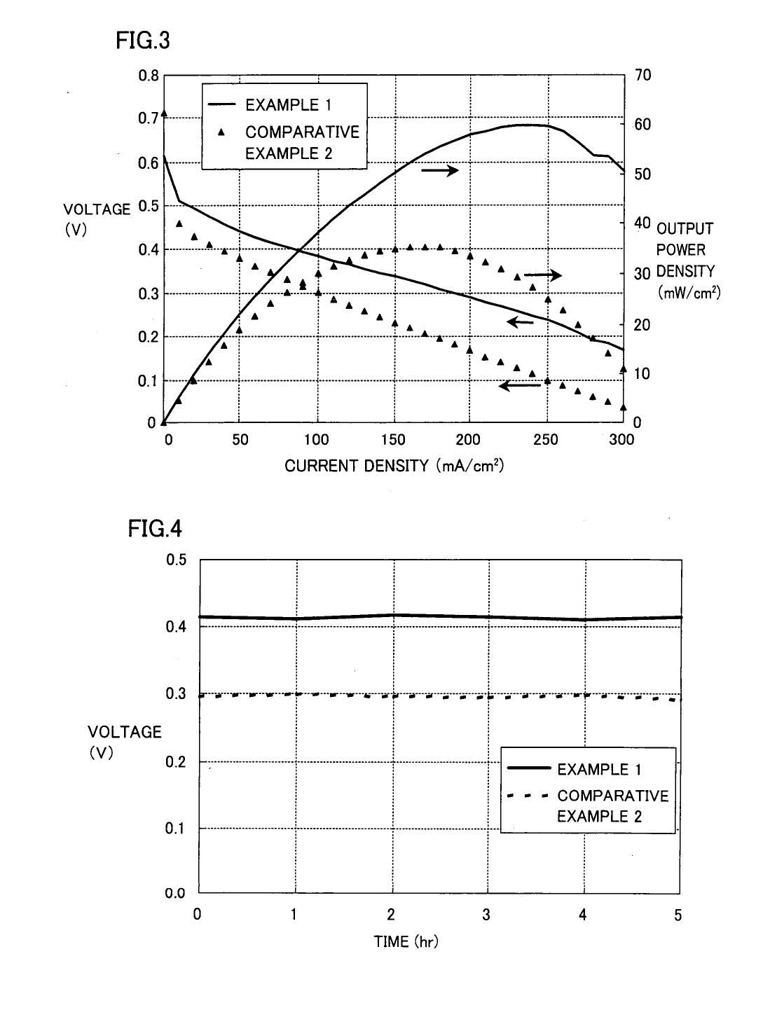

FIG. 3 is a graph showing relation between current density (mA), voltage (V) and output density (mW/cm²) for MEAs according to Example 1 and Comparative Example 2. FIG. 4 is a graph showing time-dependent voltage variations under the constant current load for MEAs according to Example 1 and Comparative Example 2.

It can be understood from FIG. 3 that the power generation efficiency is higher and thus the catalytic reaction resistance is reduced in Example 1 as compared with Comparative Example 2. In FIG. 4, the higher voltage can also be obtained under the constant current load in Example 1 as compared with Comparative Example 2.

### COMPARATIVE EXAMPLE 3

In Comparative Example 3, a catalyst for a positive electrode and a catalyst for a negative electrode were also prepared by a process similar to that of Example 1, except that 50 mL propanol solution including 2.0 wt. % of a silane coupling agent was used in place of Solsperse 20000 as the polymer pigment dispersant.

In the catalyst for the positive electrode according to Comparative Example 3, the average size of the platinum particles was 2.3 nm with the maximum size of 4.5 nm, and the amount of platinum particles was 30 wt. %.

In this Comparative Example 3, elements present in the carbon surface of the catalyst for the positive electrode were 94.2% C, 2.9% Pt, 0.07% N, 0.8% O, and 2.0% Si by the number ratio of atoms, and no element other than these was detected. In the carbon surface of the catalyst for the positive electrode, therefore, the number ratio of nitrogen atoms to oxygen atoms was 0.07/0.8×100=about 8.8% and the number ratio of silicon atoms to oxygen atoms was 2.0/0.8×100=250%.

In the catalyst for the negative electrode in this Comparative Example 3, the average size of the platinum-ruthenium alloy particles was 3.1 nm with the maximum size of 6.0 nm, and the amount of platinum was 26 wt. % and the amount of ruthenium was 13 wt. %.

In this Comparative Example 3, elements present in the carbon surface of the catalyst for the negative electrode were 90.1% C, 3.7% Pt, 3.6% Ru, 0.06% N, 0.7% O, and 1.8% Si by the number ratio of atoms, and no element other than these was detected. Therefore, the number ratio of nitrogen atoms to oxygen atoms was 0.06/0.7×100=about 8.6% and the number ratio of silicon atoms to oxygen atoms was 1.8/0.7×100=about 257%.

An MEA was prepared by a similar process as in Example 1, using the catalyst for the positive electrode and the catalyst for the negative electrode according to this Comparative Example 3.

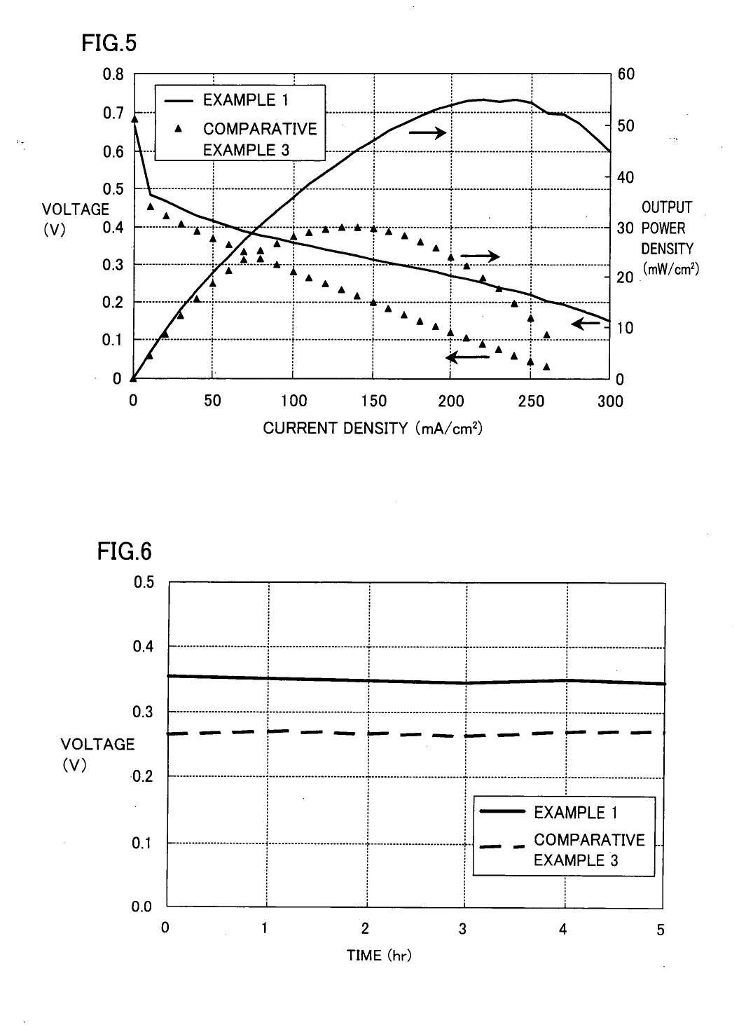

FIG. 5 is a graph showing relation between current density (mA), voltage (V) and output density (mW/cm²) for MEAs according to Example 1 and Comparative Example 3. FIG. 6 is a graph showing time-dependent voltage variations under the constant current load for MEAs according to Example 1 and Comparative Example 3.

It can be understood from FIG. 5 that the power generation efficiency is higher and thus the catalytic reaction resistance is reduced in Example 1 as compared with Comparative Example 3. The reason can be assumed that, in Comparative Example 3, silicon (Si) derived from the polymer pigment dispersant was present as residues on the catalyst surface, which restricted the catalytic reaction, causing higher catalytic reaction resistance and lower power generation efficiency. In FIG. 6, the higher voltage can also be obtained under the constant current load in Example 1 as compared with Comparative Example 3.

### COMPARATIVE EXAMPLE 4

In Comparative Example 4, a catalyst for a positive electrode was prepared by a process similar to that of Example 1, except that 1-propanol solution including 0.61 wt. % dinitrodiammine platinum-(II) was used as the noble metal solution.

In the catalyst for the positive electrode according to this Comparative Example 4, the average size of the platinum particles was 2.5 nm with the maximum size of 4.2 nm, and the amount of platinum particles was 30 wt. %.

In this Comparative Example 4, elements present in the carbon surface of the catalyst for the positive electrode were 96.7% C, 2.7% Pt, 0.2% N, and 0.4% O by the number ratio of atoms, and no element other than these was detected. In the carbon surface of the catalyst for the positive electrode, therefore, the number ratio of nitrogen atoms to oxygen atoms was 0.2/0.4×100=50% and the number ratio of silicon atoms to oxygen atoms was 0%.

On the other hand, a carbon powder supporting platinum-ruthenium alloy particles was prepared as a catalyst for a negative electrode by adding a 1-propanol solution including 0.40 wt. % ruthenium nitrosyl chloride as the noble metal solution to a propanol dispersion solution including 40 wt. % of the carbon powder supporting platinum particles of this Comparative Example 4. In this catalyst for the negative electrode, the average size of the platinum ruthenium alloy particles was 3.2 nm with the maximum size of 5.8 nm, and the amount of platinum was 26 wt. % and the amount of ruthenium was 13 wt. %.

In this Comparative Example 4, elements present in the carbon surface of the catalyst for the negative electrode were 90.8% C, 3.4% Pt, 3.5% Ru, 0.8% N, and 1.5% O by the number ratio of atoms, and no element other than these was detected. In the carbon surface of the catalyst for the negative electrode, therefore, the number ratio of nitrogen atoms to oxygen atoms was 0.8/15×100=about 53% and the number ratio of silicon atoms to oxygen atoms was 0%.

An MEA was prepared by a similar process as in Example 1, using the catalyst for the positive electrode and the catalyst for the negative electrode according to this Comparative Example 4.

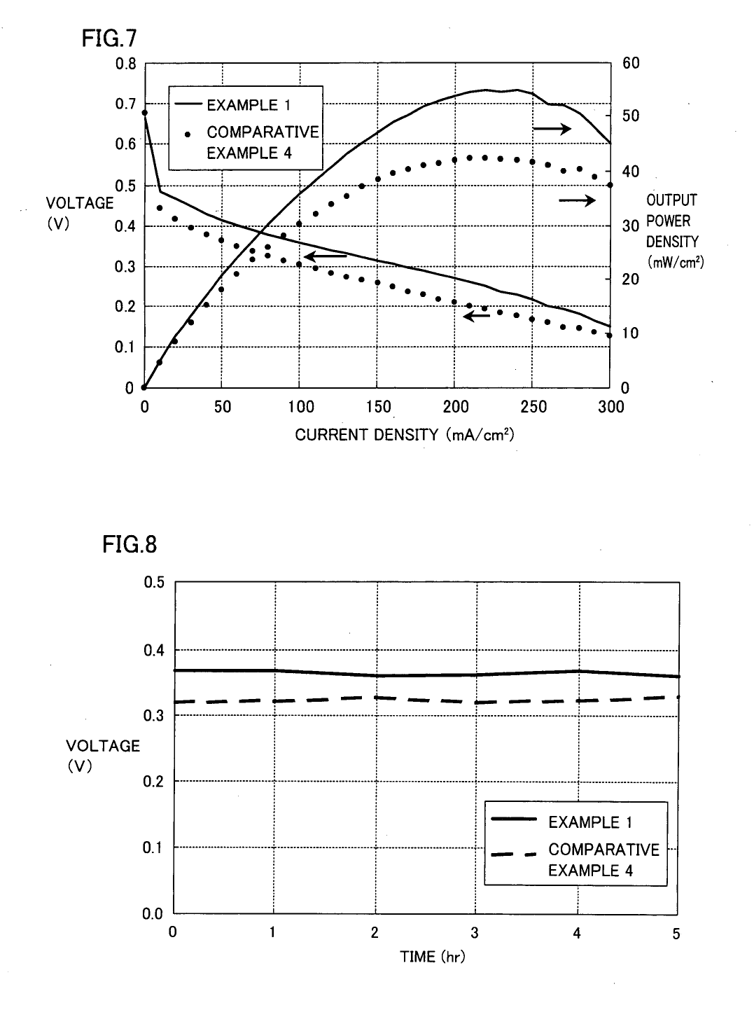

FIG. 7 is a graph showing relation between current density (mA), voltage (V) and output density (mW/cm²) for MEAs according to Example 1 and Comparative Example 4. FIG. 8 is a graph showing time-dependent voltage variations under the constant current load for MEAs according to Example 1 and Comparative Example 4.

It can be understood from FIG. 7 that the power generation efficiency is higher and thus the catalytic reaction resistance is reduced in Example 1 as compared with Comparative Example 4. The reason can be assumed that, in Comparative Example 4, nitrogen (N) derived from ruthenium nitrosyl chloride was present as residues on the noble metal particle surface, which restricted the catalytic reaction, causing higher catalytic reaction resistance and lower power generation efficiency. In FIG. 8, the higher voltage can also be obtained under the constant current load in Example 1 as compared with Comparative Example 4.

The catalyst including noble metal particles on the carbon substrate obtained by the present invention has excellent catalytic activity and can preferably be used for applications such as fuel cells and electrochemical processes.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A catalyst including a carbon substrate and noble metal particles supported on the carbon substrate, wherein
an average size of said noble metal particles is at most 3 nm, and
in elements present in a surface of said carbon substrate, a number ratio of nitrogen atoms to oxygen atoms is at most 10% and a number ratio of silicon atoms to oxygen atoms is at most 40%.

2. A method of producing the catalyst of claim 1, comprising the steps of:
preparing a carbon powder dispersion liquid by dispersing carbon powder for said carbon substrate in a solvent; and
adding a noble metal solution to said carbon powder dispersion liquid to form said noble metal particles supported on said carbon substrate.

3. The method according to claim 2, wherein at least one of said carbon powder dispersion liquid and said noble metal solution further includes a polymer pigment dispersant.

4. The method according to claim 3, wherein said polymer pigment dispersant is an amphipathic polymer.

5. The method according to claim 4, wherein said amphipathic polymer includes a compound having an amino group and an ether group.

6. The method according to claim 3, wherein said polymer pigment dispersant is removed after said noble metal particles are supported on said carbon substrate.

7. The method according to claim 2, wherein said carbon powder dispersion liquid is subjected to a crushing process.

8. The method according to claim 2, wherein said solvent is alcohol, and an absolute value of zeta potential of said carbon powder dispersion liquid is at least 30 mV.

9. The method according to claim 2, wherein said carbon powder dispersion liquid has pH higher than 7.

10. The method according to claim 2, wherein a mixture liquid prepared by adding said noble metal solution to said carbon powder dispersion liquid is heated.

11. The method according to claim 10, wherein after said heating, said mixture liquid is cooled at a higher rate as compared with natural cooling in an ambient air.
